(19) United States
(12) Patent Application Publication
(10) Pub. No.: US 2011/0268692 A1
(43) Pub. Date: Nov. 3, 2011

(54) Synergistic rodenticidal compositions

(75) Inventor: Stefan Endepols, Burscheid (DE)

(73) Assignee: Bayer CropScience AG, Monheim (DE)

(21) Appl. No.: 13/124,308

(22) PCT Filed: Oct. 7, 2009
(86) PCT No.: PCT/EP2009/007177

§ 371 Date: Jun. 27, 2011

(30) Foreign Application Priority Data
Oct. 14, 2008 (EP) 08166528.3

(51) Int. Cl. A01N 25/00; A01N 43/16; A01P 11/00; A01N 45/02

(52) U.S. Cl. 424/84; 514/167; 514/457

(57) ABSTRACT

The present invention relates to the combination of an active anticoagulant rodenticidal compound with an analogue of vitamin D, with at least one of the two components being used at a very low concentration.

The present invention relates to the use of vitamin D analogues in combination with anticoagulants at low concentration in rodent control compositions.

Anticoagulants, particularly hydroxycoumarins, have been used since the 1950s as active rodenticidal compounds in baits and other compositions for controlling rodents. These active compounds inhibit the activity of the enzyme vitamin K epoxide reductase, which converts oxidized vitamin K into its active form, vitamin K hydroquinone. This form of vitamin K is needed for gamma-carboxylations. A deficiency in the active form of vitamin K therefore results in inadequate carboxylation of numerous proteins, including the blood coagulation factor X. This disrupts the conversion of prothrombin into thrombin, a step in the blood coagulation cascade, which may lead in turn to a weakening and possibly the death of an animal having ingested a corresponding dose of coumarin. First-generation hydroxycoumarins are used typically at concentrations (always expressed as % by weight, unless otherwise indicated) of 0.02% to 0.06% in baits, those of the second generation at 0.0025% or 0.005%.

Another group of active compounds used as rodenticide are two forms of vitamin D, ergocalciferol and cholecalciferol (vitamin D₂ and D₃). An overdose of the vitamin results in hypercalcaemia. In that condition, calcium is absorbed to an increased extent intestinally from food, and is reabsorbed from bone minerals. The resulting high calcium concentration in the bloodstream results in the sklerotization of soft tissue, and has a damaging effect on the cardiovascular system. Calciferols are used typically in the concentration range from 0.1% to 0.6% in baits.

Active compounds from both groups are also combined with one another in rodenticidal baits (GB 1 371 135). Mixtures of the active compounds have also been described elsewhere (Greaves, J. H.; Redfern, R.; King, R. E. (1974), J. Hyg. Cambridge 73, 341-351 or Kerins, G. M.; Endepols, S.; MacNicoll, A. D. (2002), Comp. Clin. Path. 11, 59-64). In the 1970s to the 1990s, products were introduced on the market that contained either the anticoagulant warfarin in combination with ergocalciferol (0.025%+0.1%), or coumatetralyl with cholecalciferol (0.0375%+0.025%).

With the worldwide introduction of the second-generation hydroxycoumarins, the aforementioned combination products were replaced by products containing these newer active compounds. Moreover, the combination products failed to become established, since the calciferol, at the concentrations used, causes bait shyness and reduces the attractiveness of the bait to the rodents (Prescott, C. V.; El-Amin, M.; Smith, R. H. (1992): Calciferols and bait shyness in the laboratory rat. Proc. 15^{th} Vertebrate Pest Conf., Univ. Calif., Davis, 218-223). The use of lower concentrations of the calciferol did not appear to be useful, since then it would not be possible to ensure sufficient boosting of activity in comparison to the anticoagulant without calciferol.

In feeding tests with rats and mice, unexpectedly good activity was then found for the above combination, in certain strains of animals, even when both active compounds were used at a concentration which was below that typically employed. A surprising fact was that the concentration of one of the two active compounds can in fact be lowered substantially below the typical concentration, i.e. to a level of only; for example, 0.01% or 0.005% of cholecalciferol. Even with an amount of both active compounds in the region of the minimum value of the concentration ranges disclosed in GB 1 371 135, the activity found was good. This could not have been anticipated, since the examples given in GB 1 371 135 disclose the presence of at least one of the two components at a relatively high concentration, e.g. 0.1%. Performing the teaching disclosed in GB 1 371 135 in the extreme lower limit range, therefore, would not have been seriously contemplated by a person skilled in the art.

A particularly surprising fact was that the amount of one of the two combined active compounds could be lowered in concentration even further, i.e. substantially lower than the minimum concentration claimed in GB 1 371 135. Hence it was possible to combine the active compounds coumatetralyl (first-generation hydroxycoumarin) and cholecalciferol (vitamin D₃) in such a way that one of the two active compounds was present only at 0.0025% in the bait, and nevertheless an extraordinarily good activity was shown. This concentration amounts to only 50% of the minimum concentration claimed in the patent cited above.

Although GB 1 371 135 claims concentrations in each case above 0.005%, activity appears—as also demonstrated by examples therein—to be plausible only at substantially higher concentrations. It could not, therefore, have been expected that concentrations of even 0.0025% would exhibit a synergistic effect, and particularly in the case of insensitive wild strains of the house mouse (Mus musculus) and of the brown rat (Rattus norvegicus).

The present invention relates to the combination of at least one active anticoagulant rodenticidal compound with an analogue of vitamin D, with at least one of the two components being used at a very low concentration (equal to or less than 0.0049%).

Anticoagulants in the sense of the invention are compounds from the group of the indanedione derivatives or hydroxycoumarins, generations 1 and 2. These substances are used worldwide for controlling rodents (cf., for example, DE 2506769; JP 48023942; CH 481580; Paposci (1974): Beihefte Z. Angew. Zool. p. 155 and DE 2506769). Examples of 1st-generation anticoagulant substances include the 4-hydroxycoumarin derivatives (1-phenyl-2-acetyl)-3-ethyl-4-hydroxycoumarin (“warfarin”), 3-(α-acetonyl-4-chlorobenzyl)-4-hydroxycoumarin (“coumachlor”), 3-(1′,2′,3′,4′-tetrahydro-1′-naphthyl)-4-hydroxycoumarin (“coumatetralyl”), and the indanedione derivatives, such as 1,1-diphenyl-2-acetylindane-1,3-dione (“diphacinone”) and (1′-p-chlorophenyl-1′-phenyl)-2-acetylindane-1,3-dione (“chlorodiphacinone”). The 2nd generation includes the following: 3-[3-(4′-hydroxy-3′-coumarinyl)-3-phenyl-1-(4′-bromo-4′-biphenyl)propan-1-ol (“bromadiolone”), 3-(3′-paradiphenylyl-1′,2′,3′,4′-tetrahydro-1′-naphthyl)-4-hydroxycoumarin (“difenacoum“), 3-[3-4′-bromobiphenyl-4 -yl)-1,2,3,4-tetrahydro-1-naphthyl]-4-hydroxycoumarin (”brodifacoum“), 4-hydroxy-3-[1,2,3,4-tetrahydro-3-[4-(4-trifluoromethylbenzyloxy)phenyl]-1-naphthyl]coumarin (”flocoumafen”), and the hydroxy-4-benzothiopyranones, e.g. “difethialone”.

Further anticoagulants suitable for producing the baits of the invention include the following 2-azacycloalkylmethyl-substituted benzhydryl ketones and benzhydryl carbinols: 1-phenyl-3 -(2-piperidyl)-1 -(p-tolyl)-2-propanone, 3,3 -diphenyl-1 -(2-pyrrolidinyl)-2-pentanone, 1,1-diphenyl-3-[2-(hexahydro-1H-azepinyl)]-2-propanone, 1-(4-fluorophenyl)-1-phenyl-3-(2-piperidyl)-2-propanone, 1-(4-methylthiophenyl)-1-phenyl-3-(5,5-dimethyl-2-pyrrolidinyl)-2-propanone, 1-(p-coumenyl)-1-phenyl-3-(4-tert-butyl-2-piperidinyl)-2-propanone, 3,3-diphenyl-1-[2-(hexahydro-1H-azepinyl]-2-butanone, 3-(2,4-dichlorophenyl)-3-phenyl-1-(2-piperidyl)-2-heptanone, 1,1-diphenyl-3-(5-methyl-2-pyrrolidinyl)-2-propanone, 3,3-diphenyl-1-(2-piperidyl)-2-butanone, α-(α-methyl-α-phenylbenzyl)-2-piperidineethanol, α-(α-ethyl-α-phenylbenzyl)-2-pyrrolidineethanol, (2,5-dimethyl-α-phenylbenzyl)-2-piperidineethanol and α-(diphenylmethyl)-2-(hexahydro-1H-azepin)ethanol and salts thereof, which are described in DT-OS 2 417 783, and also 4′-(fluorophenyl)-2-(2-pyrrolidinyl)acetophenone, 4′-phenyl-2-(5,5-dimethyl-2-pyrrolidinyl)-acetophenone, 4′-[p-(trifluoromethyl)phenyl]-2-(2-piperidyl)acetophenone, 4′-(p-butoxyphenyl)-2-(4-tert-butyl-2-piperidyl)acetophenone, 2′-phenoxy-2-(2-piperidyl)acetophenone, 4′-(p-fluorophenoxy)-2-(5,5-dimethyl-2-pyrrolidinyl)acetophenone, 4′-(p-chlorophenoxy)-2-(2-piperidyl)acetophenone, 4′[m-(trifluoromethyl)phenoxy]-2-(2-piperidyl)acetophenone, 4′-(p-butoxyphenoxy)-2-(2-pyrrolidinyl)acetophenone, 2-(2-piperidyl)-4′-(trans-p-tolylvinylene)-acetophenone, 2-(2-hexahydro-1H-azepinyl)-4′-(trans-styryl)acetophenone, 4′-(m-methoxy-phenylvinylene)-2-(2-pyrrolidinyl)acetophenone, 2-(2-piperidyl)-4′- [(p-methylthio)phenyl-vinylene]acetophenone, 4′-(3-phenoxypropoxy)-2-(2-piperidyl)acetophenone, 4′-(4-phenylbutyl)-2-(2-piperidyl)acetophenone, 4′-(α, α-dimethylbenzyl)-2-(piperidyl)acetophenone, 4′-phenethyl-2-(3,5-diethyl-2-piperidyl)acetophenone, 4′-phenyl-2-(2-pyrrolidinyl)acetophenone, α-[2-(2-phenylethoxy)phenyl]-2-piperidineethanol, α-(p-phenoxyphenyl)-2-pyrrolidineethanol, α-[4-(4-bromophenoxy)phenyl]-6-methyl-2-piperidineethanol, α-(p-phenethyl)phenyl-2-pyrrolidineethanol, α-p-bisphenyl-2-hexanhydro-1H-azepinethanol, α[3-(4-phenoxybutoxy)-phenyl]-2-piperidineethanol and α-(4-benzyl)phenyl-2-piperidineethanol and salts thereof (cf. DE-A-2 418 480).

The following rare earth metal salts may likewise be used as anticoagulants: dineodymium dihydroxybenzenedisulfonate (Acta physiol. Acad. Sci. Hungar. 24, 373), dineodymium 3-sulfonatopyridine-4-carboxylate and cerium(III) tris(4-aminobenzenesulfonate).

Inventively preferred anticoagulants are the 1st-generation anticoagulants warfarin, coumatetralyl, chlorophacinone and diphacinone, and those of the 2nd generation such as bromadiolone, difenacoum, brodifacoum, flocoumafen and difethialone.

Vitamin D analogues in the sense of the invention are ergocalciferol and cholecalciferol. They are derivatives of a 3β-hydroxy-Δ5,7-17β-substituted steroid. Calciferols are formed from ergosterol by irradiation. Furthermore, other analogues and metabolites of vitamin D are suitable, such as hydroxycholecalciferol, dihydroxycholecalciferol, hydroxyergocalciferol, and dihydroxy-ergocalciferol, for example. Preference is given to ergocalciferol and cholecalciferol.

In the compositions of the invention there may also be two or more anticoagulants and/or vitamin D analogues present (in such a case, the concentration figures apply to the total amount of anticoagulants and of vitamin D analogues respectively).

In the compositions of the invention, at least either the anticoagulant or the vitamin D analogue is present at a concentration equal to or less than 0.0049%, preferably between 0.001% and 0.0045%, more preferably between 0.002% and 0.004%, very preferably between 0.0025% and 0.0035%.

Where the anticoagulant in the compositions of the invention is present up to a maximum of 0.0049%, preferably between 0.001% and 0.0045%, more preferably between 0.002% and 0.004%, very preferably between 0.0025% and 0.003%, the vitamin D analogue may be present, as is usual, at 0.005% to 1.0%.

Where the vitamin D analogue in the compositions of the invention is present up to a maximum of 0.0049%, preferably between 0.001% and 0.0045%, more preferably between 0.002% and 0.004%, very preferably between 0.0025% and 0.0035%, the anticoagulant may be present, as is usual, at 0.005% to 1.0%.

In another embodiment, in the compositions of the invention, both anticoagulant and vitamin D analogue are present at not more than 0.0049%, preferably between 0.001% and 0.0049%, more preferably between 0.001% and 0.0045%, very preferably between 0.002% and 0.004%, and with particular preference between 0.025% and 0.0035%.

The following combinations are examples of particularly suitable combinations of anticoagulant and vitamin D analogue:

a) coumatetralyl and cholecalciferol

b) coumatetralyl and ergocalciferol

c) chlorophacinone and cholecalciferol

d) chlorophacinone and ergocalciferol

The following combinations are examples of particularly suitable combinations and concentration figures of anticoagulant and vitamin D analogue:

a) anticoagulant (0.001% to 0.0049%)+ergo/cholecalciferol (0.005% to 0.5%);

b) anticoagulant (0.005% to 0.1%)+ergo/cholecalciferol (0.001% to 0.0049%);

c) anticoagulant (0.001% to 0.0049%)+ergo/cholecalciferol (0.001% to 0.0049%);

The following combinations are examples of suitable concentrations of the active compound combination of coumatetralyl+cholecalciferol:

a) coumatetralyl (0.0025%)+cholecalciferol (0.025%);

b) coumatetralyl (0.0375%)+cholecalciferol (0.0025%);

c) coumatetralyl (0.004%)+cholecalciferol (0.004%);

Rodenticidal control compositions in the sense of the invention are all types of rodenticidal baits. These are sufficiently well known from the prior art. Recommendation is given to those based on cereals, such as rolled oats, wheat, maize, etc. These may be pourable baits comprising one or more cereal ingredients, extruded baits such as granules or pellets, wax blocks, soft or pasty mixtures based on vegetable fats and meals, or gels based on oily or aqueous formulations. Particularly worthy of recommendation are pasty baits consisting of cereals or meals and vegetable fat. Very suitable examples include pasty baits in portion packs of 10 g to 200 g.

Other forms of administration are liquid or gelled drinks and also so-called contact compositions such as powders and foams. These compositions are not baits, but instead are delivered to adhere to the fur of the rodent and to be ingested orally only on grooming.

The compositions of the invention are suitable for controlling all kinds of rodent pests, including representatives of the genera Microtus, Arvicola, Rattus and Mus. In the area populated by people, particularly noteworthy are the house mouse, Mus musculus/domesticus, the brown rat, Rattus norvegicus, and the roof, house or black rat, R. rattus. Use on open land is possible, as is use in buildings, including animal stalls, storage and production areas, and in the sewer system.

### EXAMPLES

1) Bait based on whole wheat with the anticoagulant coumatetralyl in typical concentration (0.0375% w/w) and the vitamin D analogue cholecalciferol (0.0025% w/w). The composition was tested in a feeding test over 5 days with house mice (Mus muscuius domesticus) of a wild strain. The mortality was 95% (n=20).

2) Bait based on whole wheat with the anticoagulant coumatetralyl (0.0045% w/w) and the vitamin D analogue cholecalciferol (0.005% w/w). The composition was tested in a feeding test over 4 days with brown rats (Rattus norvegicus) of a wild strain. The mortality was 100% (n=12).

3) Bait based on whole wheat with the anticoagulant coumatetralyl (0.0025% w/w) and the vitamin D analogue cholecalciferol (0.01% w/w). The composition was tested in a feeding test over 4 days with brown rats (Rattus norvegicus) of a wild strain. The mortality was 100% (n=12).

1. A composition for controlling rodents, comprising at least one anticoagulant and at least one vitamin D analogue, wherein at least one of the at least one anticoagulant and the at least one vitamin D analogue is present in an amount of not more than 0.0049% by weight.

2. The composition as claimed in claim 1, wherein the at least one anticoagulant is a hydroxycoumarin or an indanedione derivative.

3. The composition as claimed in claim 1, wherein the at least one vitamin D analogue is selected from the group consisting of ergocalciferol and cholecalciferol.

4. The composition as claimed in claim 1, wherein the at least one anticoagulant is present in an amount of not more than 0.0049% by weight.

5. The composition as claimed in claim 1, wherein the at least one vitamin D analogue is present in an amount of not more than 0.0049% by weight.

6. The composition as claimed in claim 1, wherein the at least one anticoagulant and the at least one vitamin D analogue are present in an amount of not more than 0.0049% by weight.

7. The composition as claimed in claim 1, wherein the at least one anticoagulant is present in an amount between 0.001% and 0.0045% by weight and the at least one vitamin D analogue is present in an amount between 0.005% to 1.0% by weight.

8. The composition as claimed in claim 1, wherein the at least one vitamin D analogue is present in an amount between 0.001% and 0.0045% by weight and the at least one anticoagulant is present in an amount between 0.005% to 1.0% by weight.

9. The composition as claimed in claim 6, wherein the at least one anticoagulant and the at least one vitamin D analogue are present in an amount between 0.001% and 0.0049% by weight.

10. The composition as claimed in claim 1, which is in the form of a bait for rodents.
